(19) United States
(12) Patent Application Publication
(10) Pub. No.: US 2010/0207723 A1
(43) Pub. Date: Aug. 19, 2010

(54) ELECTRICALLY LOCKING DEVICE AND ELECTRIC LOCK SYSTEM AND UNLOCKING METHOD THEREOF

(75) Inventors: Shuai Cao, Shenzhen City (CN); Mao-Yu Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu Cheng (TW)

(21) Appl. No.: 12/541,172

(22) Filed: Aug. 14, 2009

(30) Foreign Application Priority Data
Feb. 18, 2009 (CN) 200910300458.8

(51) Int. Cl. G05B 19/00

(52) U.S. Cl. 340/5.61

(57) ABSTRACT

An electric lock system includes an electrically locking device including a memory unit, a first communication unit, an electric lock and a first processing unit, and a wireless communication device including a second communication unit, a second processing unit, and a second input unit. The memory unit stores an unlock code, a request code and a message. The first processing unit compares an input code with the request code and controls the first communication unit to transmit the message to the communication device if the input code matches the request code. The second processing unit controls the second communication unit to transmit an unlock request code to the first communication unit according to the message received by the second communication unit. The first processing unit compares the unlock request code with the unlock code, and unlocks the electric lock if the unlock request code matches the unlock code.

### BACKGROUND

1. Technical Field

The present disclosure relates to locks, and particularly, to an electrically locking device and an electric lock system and an unlocking method thereof.

2. Description of Related Art

Electric lock system has been developed, which allows people to open a door without a conventional key. The electric lock system includes various kinds of electric locks, such as an integrated circuit card (IC-card) electric lock and a radio-frequency-identification (RFID) electric lock. However, when these electric locks are used, people have to take with an IC card and an RFID card to unlock the electric lock. This is inconvenient.

Therefore, there is a need exist for an electrically locking device and an electric lock system and an unlocking method thereof, in which the above problem is eliminated or at least alleviated.

### BRIEF DESCRIPTION OF THE DRAWINGS

FIG. 1 is a functional block diagram of an electric lock system, according to an exemplary embodiment.

FIG. 2 is a flow chart of an unlocking method of an electric lock system, according to another exemplary embodiment.

### DETAILED DESCRIPTION

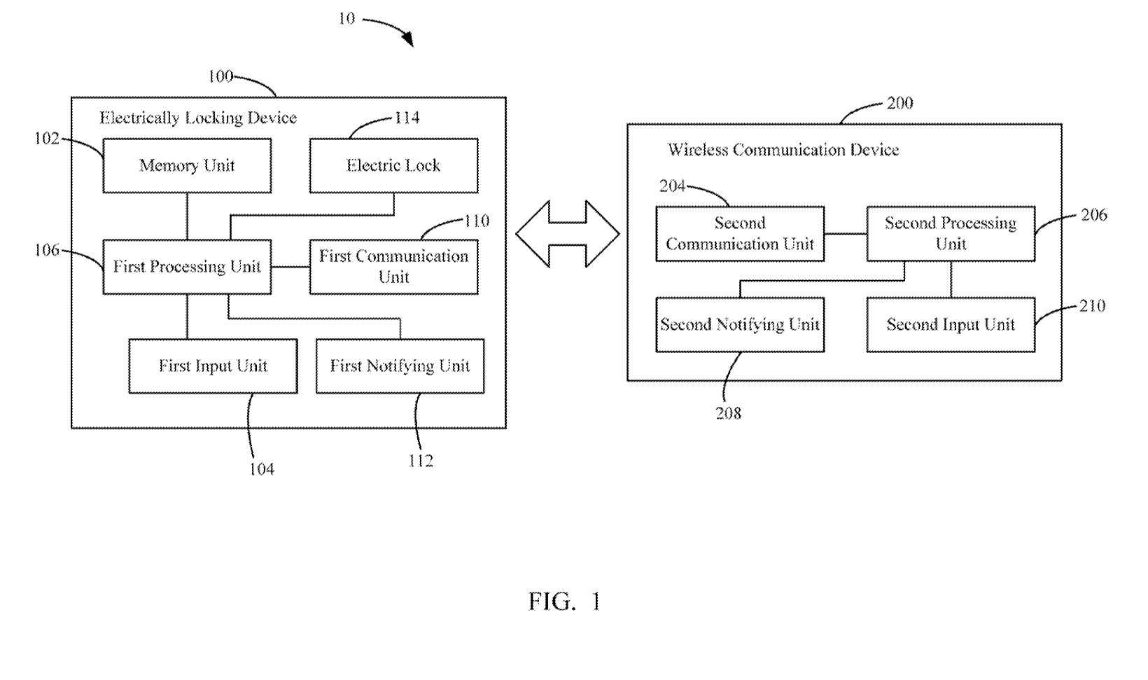

Referring to FIG. 1, an electric lock system 10, according to an exemplary embodiment, includes an electrically locking device 100 and a wireless communication device 200. The wireless communication device 200 may be a cellular phone. The electric lock system 10 may be applied to a door of a house.

The electrically locking device 100 includes a memory unit 102, a first input unit 104, a first processing unit 106, a first communication unit 110, a first notifying unit 112 and an electric lock 114.

The memory unit 102 is configured for storing an unlock code, a request code, and a request message. The unlock code, the request code and the request message may be predetermined/changed by a user of the electric lock system 10.

The first input unit 104 is configured for generating an input code according to the user's input. The first input unit 104 may include a keypad and/or a touch screen for the user to input. The first communication unit 110 is configured for transmitting the request message to the wireless communication device 200.

The first processing unit 106 is configured for comparing the input code with the request code and controlling the first communication unit 110 to transmit the request message to the wireless communication device 200 if the input code matches the request code.

The first communication unit 110 is further configured for receiving an unlock request code transmitted from the wireless communication device 200. The first processing unit 106 is further configured for comparing the received unlock request code with the unlock code and unlocking the electric lock 114 if the received unlock request code matches the unlock code. The first processing unit 106 is further configured for controlling the first notifying unit 112 to notify the user if the received unlock request code is different from the unlock code and if the input code is different from the request code. The first notifying unit 112 may include a light emitter and/or a sound emitter. The electric lock 114 may be attached to a door.

The wireless communication device 200 includes a second communication unit 204, a second processing unit 206, a second notifying unit 208, and a second input unit 210.

The second communication unit 204 is configured for receiving the request message transmitted from the first communication unit 110. The second processing unit 206 is configured for controlling the second notifying unit 208 to notify the user of the wireless communication device 200 according to the received request message. The second notifying unit 208 may include a light emitter and/or a sound emitter.

The second input unit 210 is configured for generating the unlock request code according to the user's input after the request message is received. The second input unit 210 may include a keypad and/or a touch screen for the user to input. The second processing unit 206 is configured for controlling the second communication unit 204 to transmit the unlock request code to the first communication unit 110.

The first communication unit 110 and the second communication unit 204 may include global system for mobile communications (GSM) units.

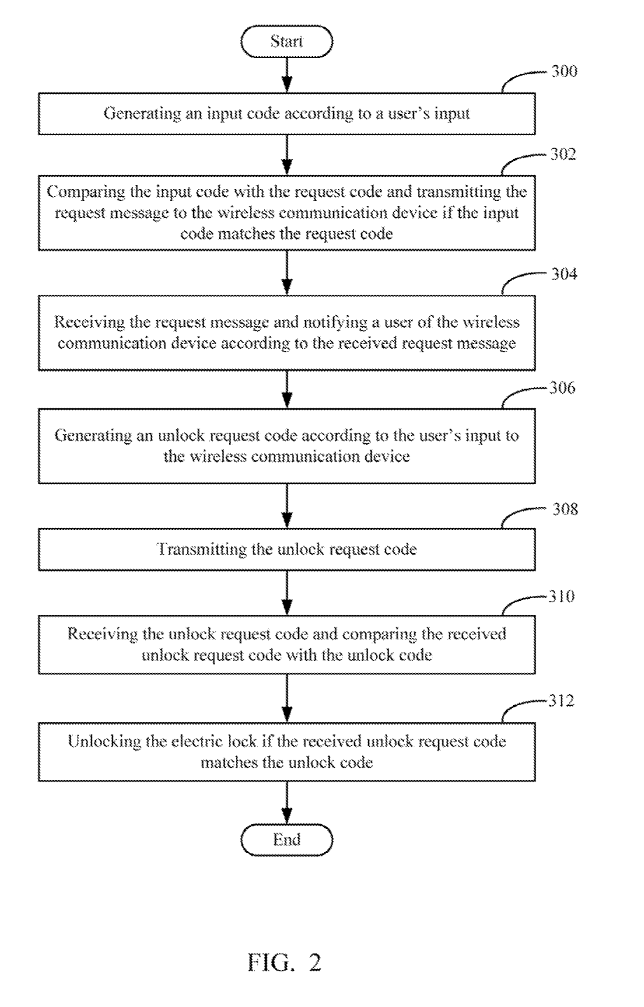

Referring to FIG. 2, an unlocking method of the electric lock system 10, according to another exemplary embodiment, includes step 300 through step 312. Step 300: generating an input code according to a user's input. Step 302: comparing the input code with the request code and transmitting the request message to the wireless communication device 200 if the input code matches the request code. Step 304: receiving the request message and notifying a user of the wireless communication device according to the received request message. Step 306: generating an unlock request code according to the user's input to the wireless communication device. Step 308: transmitting the unlock request code. Step 310: receiving the unlock request code and comparing the received unlock request code with the unlock code. Step 312: unlocking the electric lock if the received unlock request code matches the unlock code.

It is note that the user changing the unlock code, the request code and the request message may be different from the user inputting the input code, and the request message can be sent to anyone of the users. For example, the user changing the unlock code, the request code and the request message may be a host of the house where the electric lock system 10 is applied, and the user inputting the input code may be a visitor to the house.

The electric lock system and an unlocking method thereof can allow people to open a door without a IC-card and a RFID card. Moreover, when a user of the electric lock system 10, such as a host, is not home, his visitor can enter his home with his authorization. This is convenient.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electric lock system, comprising:
an electrically locking device comprising a memory unit, a first processing unit, a first communication unit, and an electric lock, the memory unit configured for storing an unlock code, a request code and a request message; and
a wireless communication device comprising a second communication unit, a second processing unit, and a second input unit;
wherein the first processing unit is configured for comparing an input code with the request code and controlling the first communication unit to transmit the request message to the wireless communication device if the input code matches the request code, and the second communication unit is configured for receiving the request message and the second processing unit is configured for controlling the second communication unit to transmit an input unlock request code to the first communication unit according to the received request message, and the first processing unit is configured for comparing the unlock request code received by the first communication unit with the unlock code, and unlocking the electric lock if the unlock request code matches the unlock code.

2. The electric lock system as claimed in claim 1, wherein the electrically locking device further comprises a first input unit configured for generating the input code according to a user's input.

3. The electric lock system as claimed in claim 2, wherein the electrically locking device further comprises a first notifying unit configured for notifying the user if the input code is different from the request code.

4. The electric lock system as claimed in claim 1, wherein the first communication unit is a global system for mobile communications unit.

5. The electric lock system as claimed in claim 4, wherein the second communication unit is a global system for mobile communications unit.

6. The electric lock system as claimed in claim 1, wherein the wireless communication device further comprises a second input unit configured for generating the unlock request code according to an input of a user of the wireless communication device.

7. The electric lock system as claimed in claim 6, wherein the wireless communication device further comprises a second notifying unit configured for notifying the user once the request message is received.

8. The electric lock system as claimed in claim 1, wherein the wireless communication device is a cellular phone.

9. An electrically locking device communicating with a wireless communication device, comprising:
a memory unit configured for storing an unlock code, a request code and a request message;
a communication unit configured for transmitting the request message to the wireless communication device and configured for receiving an unlock request code transmitted from the wireless communication device;
an electric lock; and
a processing unit configured for comparing an input code with the request code, and configured for controlling the first communication unit to transmit the request message to the wireless communication device if the input code matches the request code and configured for comparing the received unlock request code with the unlock code and configured for unlocking the electric lock if the received unlock request code matches the unlock code.

10. The electrically locking device as claimed in claim 9, further comprising an input unit configured for generating the input code according to a user's input.

11. The electrically locking device as claimed in claim 10, further comprising a notifying unit configured for notifying the user if the input code is different from the request code.

12. The electrically locking device as claimed in claim 9, wherein the communication unit is a global system for mobile communications unit.

13. An unlocking method of an electric lock system, the electric lock system configured for storing an unlock code, a request code and a request message and comprising a wireless communication device and an electric lock, the method comprising:
generating an input code according to a user's input;
comparing the input code with the request code and transmitting the request message to the wireless communication device if the input code matches the request code;
receiving the request message and notifying a user of the wireless communication device according to the received request message.
generating an unlock request code according to the user's input to the wireless communication device and transmitting the unlock request code;
receiving the unlock request code and comparing the received unlock request code with the unlock code; and
unlocking the electric lock if the received unlock request code matches the unlock code.

14. The method as claimed in claim 13, further comprising: notifying the user if the input code is different from the request code.

15. The method as claimed in claim 13, further comprising: notifying the user if the unlock request code is different from the unlock code.
